(19) United States
(12) Patent Application Publication
(10) Pub. No.: US 2025/0386824 A1
(43) Pub. Date: Dec. 25, 2025

(54) COMPOSITION OF AN ORGANIC SULFIDE COMBINED WITH GLUCOSE AND USE THEREOF IN CONTROLLING MELON FUSARIUM WILT

(71) Applicant: CH BIOTECH R&D CO., LTD., Nantou City (TW)

(72) Inventors: Chien Hao CHAI, Nantou City (TW); Cheng-Fang HONG, Nantou City (TW); Jenn Wen HUANG, Nantou City (TW)

(21) Appl. No.: 18/751,564

(22) Filed: Jun. 24, 2024

(51) Int. Cl. A01N 43/16; A01N 41/08; A01N 41/12; A01P 3/00

(52) U.S. Cl. CPC A01N 43/16; A01N 41/08; A01N 41/12; A01P 3/00

(57) ABSTRACT

The present invention provides a composition for controlling melon Fusarium wilt (MFW), comprising an organic sulfide combined with glucose in certain ratio. The composition of present invention may be applied to melon plants by foliar spray to effectively protect the melon plant from phytopathogenic Fusarium oxysporum f.sp. melonis (FOM) infection, and thus reduce the disease severity and prevent the onset of wilting symptoms in the melon plant.

### FIELD OF THE INVENTION

The present invention relates to a composition comprising an organic sulfide used in controlling melon Fusarium wilt. In particular, the present invention relates to a combination of an organic sulfide and glucose for inhibiting the infection by Fusarium oxysporum f.sp melonis and preventing symptoms of melon wilt disease.

### BACKGROUND OF THE INVENTION

Melons (Cucumis melo L.) include melon, cantaloupes and honeydew melon. The main cultivation areas for melons in Taiwan are Yilan County, Yunlin County, Chiayi County, Tainan County and Pingtung County. An important fungal disease affecting melon plants is melon Fusarium wilt (MFW) caused by Fusarium oxysporum f.sp melonis (abbreviated as FOM). FOM is a soil-inhabiting phytopathogenic fungus, and its chlamydospores can survive for many years in a dormant state and are difficult to eradicate. Melon Fusarium wilt may occur at all growth stages of melon and will significantly impact the quality and yield of melons.

Currently, melon Fusarium wilt is mostly controlled by using disease-resistant breeding, chemical infusion and application of soil additives. However, obtaining disease-resistant varieties will be time-consuming and not easy to breed successfully, while chemical infusion will cause the environment pollution and be poisonous to people and animals. In addition, the effect of soil additives is unstable and it is required to apply large amounts of additives to the soil before planting, which is not easily adopted and accepted by the farmers. Therefore, to develop friendly foliar spray materials for controlling soil spreading Melon Fusarium wilt is the goal of plant protection workers.

Nowadays, many biologically controlling methods for fungal plant diseases have been developed around the world. For instance, antagonistic microorganisms or secondary metabolites thereof are applied as an alternative to conventional chemical pesticides. In a previous study, Huang et al. found that an antifungal volatile dimethyl disulfide (DMDS) and ammonia from B. mycoides may be used to control crop damping-off caused by Rhizoctonia solani and Pythium aphanidermatum (see, Huang, J. S. et al., The Journal of Agricultural Science 156(6): 795-809, 2018).

Dimethyl disulfide (DMDS) is a naturally occurring organic sulfide often found in the plant tissues of Alliaceae and Brassicaceae families. DMDS has been proven to be able to control diseases caused by nematodes and soilborne pathogens, and suppress the growth of weeds. The report of Huang et al. (in Pest management science 68(9): 1306-1310, 2012) shows that the DMDS produced by Bacillus cereus strain CIL induces disease resistance in tobacco and maize plants. Obviously, the application of sulfide to strengthen the immune system of plants has great potential for developing plant disease-controlling materials.

Accordingly, the present invention first attempts to utilize an organic sulfide, such as dimethyl disulfide and the same, combined with a carbon source such as glucose, which are physiologically required by plants, in a specific ratio to formulate a plant foliar spray composition. The effects of the formulated compositions on the leaf growth of melon seedlings and the efficacy in preventing FOM infection are further evaluated in comparative analysis, and therefore a method to protect melon plants from the damage of soil-borne MFW by applying the present composition is provided.

### SUMMARY OF THE INVENTION

Accordingly, in one aspect, the present invention provides a composition used in controlling melon Fusarium wilt, comprising an organic sulfide and a carbon source combined at a ratio of 1:2˜1:4 (w/w), and an agriculturally acceptable diluent. In a preferable embodiment of the invention, the agriculturally acceptable diluent is water.

In certain embodiments of the invention, the organic sulfide comprises allicin, dimethyl disulfide (DMDS), lipoic acid, methionine and taurine. In certain embodiments of the invention, the carbon source is selected from a group composed of fructose, galactose, glucose, inositol and sucrose. In a preferable embodiment of the invention, the composition is composed of a water solution comprising 1% (w/v) of the organic sulfide and 3% (w/v) of glucose. In a preferable embodiment of the invention, the organic sulfide is dimethyl disulfide or taurine.

In certain embodiments of the invention, the composition further comprises 1% (w/v) of a potassium-containing mineral salt. In a preferable embodiment of the invention, the potassium-containing mineral salt is selected from a group composed of potassium chloride and potassium dihydrogen phosphate.

Preferably, the composition is use for inhibiting soilborne Fusarium oxysporum f.sp. melonis infection in melons. In certain embodiments of the invention, the composition is used to reduce disease severity in melon plants.

In another aspect, the present invention provides a method for controlling Melon Fusarium wilt, comprising applying the composition comprising an organic sulfide and glucose combined at a ratio of 1:2˜1:4 (w/w) to melon plants by foliar spraying. In certain embodiments of the invention, the composition further comprises a potassium-containing mineral salt, preferably potassium chloride or potassium dihydrogen phosphate.

In certain embodiments of the invention, the composition is applied to melon plants at a dilution rate of 100˜1000 in water. Preferably, the composition is applied to melon plants at a dilution rate of 200˜400 in water.

### BRIEF DESCRIPTION OF THE DRAWINGS

FIG. 1 shows the effects of 3% (w/v) glucose amended with 1% (w/v) four additional organic sulfides (allicin, lipoic acid, methionine and taurine), alongside DMDS on the disease severity of melon Fusarium wilt. The untreated control group is sprayed by sterile distilled water only. Each in three replicates and each replicate consisted of six plants. Means (n=6) in the same application method followed by the same letter are not significantly different (p>0.05) according to Kruskal-Wallis test with a Dunn's post-hoc test. Result was presented as mean±standard error (SE).

FIG. 2 shows effects of 3% (w/v) five carbon sources (fructose, galactose, glucose, inositol and sucrose) in a foliar spray composition along with DMDS on the disease severity of melon Fusarium wilt. The untreated control group is sprayed by sterile distilled water only. Each in three replicates and each replicate consisted of six plants. Means (n=6) in the same application method followed by different letters are significantly different (p<0.05) according to Kruskal-Wallis test with a Dunn's post-hoc test. Result was presented as mean #standard error (SE).

FIG. 3 shows effects of SCD amended with 1% (w/v) different mineral salts. SCD, glucose-DMDS; m-01, ammonium sulfate ((NH₄)₂SO₄); m-02, potassium hydrogen phosphate (K₂HPO₄); m-03, potassium sulfate (K₂SO₄); m-04, potassium chloride (KCl); m-05, potassium dihydrogen phosphate (KH₂PO₄); m-06, potassium nitrate (KNO₃); m-07, ammonium nitrate (NH₄NO₃); m-08, urea ((NH₂)₂CO); Untreated control, sprayed by sterile distilled water only. Columns (n=6) with different letters are significantly different (p<0.05) according to Kruskal-Wallis test with a Dunn's post-hoc test. Result was presented as mean±standard error (SE).

FIG. 4A shows effect of SCD+m-05 by foliar spraying on disease severity of melon Fusarium wilt caused by Fusarium oxysporum f.sp melonis observed at four weeks after inoculation in the microplot experiment. FIG. 4B shows effect of SCD+m-05 by foliar spraying on disease severity of Fusarium wilt of melon caused by Fusarium oxysporum f.sp melonis observed at six weeks after inoculation in the microplot experiment. Untreated control is sprayed by sterile distilled water only. In the figures, the SCD+m-05 treated melon seedlings are presented at Left side; and the untreated control melon seedlings are presented at Right side.

### DETAILED DESCRIPTION OF THE PREFERRED EMBODIMENTS

The present invention provides a composition for controlling Melon Fusarium wilt. Specifically, the composition comprises a combination of an organic sulfide and a carbon source, such as glucose, and an agriculturally acceptable diluent.

As used herein, the term “organic sulfide” or “organosulfur compound” refers to a compound with the general formula R—S—R′, where R and R′ are hydrocarbon radicals. These compounds can be considered as analogs of ethers, generated by replacing the oxygen atom with sulfur. The exemplary organic sulfides used in the present invention include allicin, dimethyl disulfide (DMDS), lipoic acid ((R)-5-(1,2-Dithiolan-3-yl)pentanoic acid), methionine and taurine (2-aminoethanesulfonic acid).

As used herein, the term “agriculturally acceptable diluent” refers to the agriculturally acceptable substrates, such as liquids, dispersants, suspensions and solvents, which act to transport the active ingredient of the present invention and make the active ingredient play its function in a plant. The diluent must be compatible with each formulation component in the composition of the invention, so that it does not have a negative impact on the plant.

As used herein, the term “controlling melon Fusarium wilt” refers to exhibit the effects of a substance or treatment on inhibiting Fusarium oxysporum f.sp. melonis (FOM) infection, or reducing the symptoms and severity of wilt disease in melon plants.

The other characteristics and advantages of the present invention will be further illustrated and described in the following examples. The examples described herein are intended for illustrations, not for limitations of the invention.

### EXAMPLES

In the following examples, a melon species Cucumis melo var. makuwa cv. Silver Light (Nongyou Seedling Co., Kaohsiung, Taiwan) is used as the test crop. Seeds of the test crop are stirred and rinsed in warm water at 65° C. for 20 minutes, then further stirred and rinsed with sterile water twice, each for 20 minutes, and then placed in a 25° C. incubator for germination for 48 hours. After the radicle has grown, the seedlings are sown in trays containing Sondermischung (perlite high) cultivating medium (Gramoflor, Germany). When the leaves are fully expanded, the seedlings are transplanted into 3.5-inch plastic pots (inner diameter: 9 cm) and continue planting. The melon plants are ready for following experiments when their first real leaves are fully expanded (the plant is about 7 days of age).

### Example 1. Effects of Different Organic Sulfide Applications on Electron Transport Rate (ETR) of Melon's Third Leaf and on the Disease Severity of Melon Fusarium Wilt

### Determination of Chlorophyll Fluorescence Photosynthesis in Melon Leaves

The compositions of 3% (w/v) glucose amended with 1% (w/v) an organic sulfide selected from allicin, dimethyl disulfide (DMDS), lipoic acid, methionine and taurine, with two hundred-fold and four hundred-fold dilution in water, are sprayed on the leaves of the melon seedlings, and the chlorophyll fluorescence photosynthesis of the third real leaf is investigated during the growing period of melons. Leaf clips are attached to a Portable Chlorophyll Fluorometer (Junior-PAM, Heinz Walz, Germany) at 08:00-11:30 AM under uniform illumination. The third real leaf of melon is clipped to measure the leaf chlorophyll fluorescence parameters. The Electron transfer rate (ETR) is calculated from the measured fluorescence parameters in terms of photosynthetic active radiation (PAR) and coefficients, and its formula was adopted from the literature of Demming-Adams & Adams (1996) as follows:

$$ETR = ( {Fm}^{′} - Fo / Fm ) \times PAR \times 0.5 \times 0.84$$

Wherein, Fm′−Fo/Fm is the photochemical yield; the unit of PAR is μmol photons m⁻² s⁻¹; 0.5 means 2 light quanta are absorbed to transfer an electron; and 0.84 is the coefficient of light quantum absorption by melon leaves. It is randomly measured 1 point on each leaf, with 5 replicates in each treatment. The test is repeated 2 times.

TABLE 1
Effect of 1% (w/v) organic sulfide applications on the
electron transport rate (ETR) of melon's third leaf

| | ETR (μmol electrons m⁻² s⁻¹) ^{a} | | | |
|---|---|---|---|---|
| Treatment | 200X | | 400X | |
| Allicin ^{b} | 106.98 ± 1.31 | a ^{c} | 111.26 ± 7.18 | a |
| DMDS | 110.24 ± 2.72 | a | 117.68 ± 3.83 | a |
| Lipoic acid | 110.52 ± 5.61 | a | 109.62 ± 8.97 | a |
| Methionine | 100.06 ± 6.70 | a | 101.18 ± 4.94 | a |
| Taurine | 109.36 ± 6.62 | a | 113.40 ± 6.36 | a |
| Untreated control | 109.00 ± 4.68 | a | 109.00 ± 4.68 | a |

^{a} The electron transport rate (ETR) of PSII on third leaf of melon after 30 minutes of halogen light source providing actinic light.
^{b} Two hundred-fold (200X) and four hundred-fold (400X) diluted 1% organic sulfide applications; Untreated control: sterile distilled water.
^{c} Means (n = 5) in each treatment followed by the same letter are not significantly different (p < 0.05) according to Fisher's Least Significant Difference (LSD) test. Result represented mean ± standard error.

As shown in Table 1, there is no significant difference in electron transfer rate between melon leaves treated with different organic sulfides. Also, there is no significant difference in comparison to the untreated control group. These results indicate that applications of two hundred-fold (200×) or four hundred-fold (400×) diluted solution of organic sulfide exhibit no negative effect on the rate of electron transfer in melon leaves.

### Evaluation of the Efficacy of Organic Sulfides in Controlling Melon Fusarium Wilt (MFW)

Preparation of the inoculation source of Fusarium oxysporum f.sp. melonis (FOM): the soil-borne pathogen FOM strain used in the example is isolated from diseased melon plants in Wufeng District, Taichung City (24°02′24.6 ″N 120°39′55.0 ″E). The single spores of the strain are independently cultured on potato dextrose agar (PDA; Difco®) medium plates in a 25° C. incubator with 12 hours of light exposure per day. The mycelial pieces of the FOM strain are inoculated into ½ potato dextrose broth (PDB) and incubated in shaking flasks for 14 days. After the incubation, the culture is filtered through a double-layer Miracloth (475855 Calbiochem, Merk Darmstadt, Germany) to obtain a spore suspension with a concentration of 10⁵ spores/mL, which is ready to be used in the pathogenic infection of melon root.

The compositions of 3% (w/v) glucose amended with 1% (w/v) an organic sulfide selected from allicin, dimethyl disulfide (DMDS), lipoic acid, methionine and taurine, with four hundred-fold dilution in distilled water, are sprayed on the whole melon plants at 7 and 14 days of age, in 3 mL and 6 mL respectively. At the 24 hours after the final spraying, the root of test melon plants is washed with water to remove the cultivating medium. Then, a cut is made at a position of 6 cm from the basal stem with a sterilized blade. Inoculation is performed by drip irrigation with the spore suspension of Fusarium oxysporum f.sp. melonis (10⁵ spores/mL) as prepared above for 15 minutes at the cut area. After FOM inoculation, the melon plants are transplanted into 3½ inch soft plastic pots (inner diameter: 9 cm) filled with Sondermischung (perlite high) (Gramoflor, Germany) cultivation medium, and continued to cultivate in a greenhouse (with a condition: 28° C. during the day, 26° C. at night; 14 hours of daylight and 10 hours of darkness). After 3 weeks, the symptoms and severity of wilt disease in melon plants are observed and recorded.

Depending on the level of damages caused by MFW in melon, the severity of wilt disease is ranked into 5 scales, ranging from 0 to 4. Scale 0: no symptoms of wilt disease appeared in melon plants. Scale 1: dwarfing appeared in melon seedlings, and withering and yellowing appeared in less than one half of the melon leaves, but no browning appeared in the vascular bundles. Scale 2: withering and yellowing appeared in more than half of the melon leaves, and no browning appeared in the vascular bundles. Scale 3: withering and yellowing appeared in more than half of the melon leaves, and the browning area in vascular bundle is not more than 10% of the total length of the melon plant; Scale 4: browning area in vascular bundle is more than 10% of the total length of the melon plant, or the whole plant appears to be dry and dead.

The disease severity is calculated by the following formula, wherein si represents the severity of wilt disease; n; represents the number of plants with various severity, and N represents the total number of plants investigated.

$$\frac{{\sum }_{i = 0}^{4} {n}_{i} \times {s}_{i}}{N} = \frac{\sum scale \times number of plants infected}{Total number of infected plants}$$

Statistical Analysis. The results are analyzed using RStudio v.4.3.0 (R) software. The effect of different organic sulfides on the electron transfer rate in melon leaves is analyzed by Fisher's least significant difference between treatment groups. Besides, an non-normal distribution of disease severity is showed in the Shapiro-Wilk test, so the data are analyzed using the non-parametricKruskal-Wallis test. If the result of Kruskal-Wallis test shows to be significant, a further comparison is performed by Dunn's post-hoc test to compare the status of the differences between individual groups. Result is presented as mean±standard error (SE).

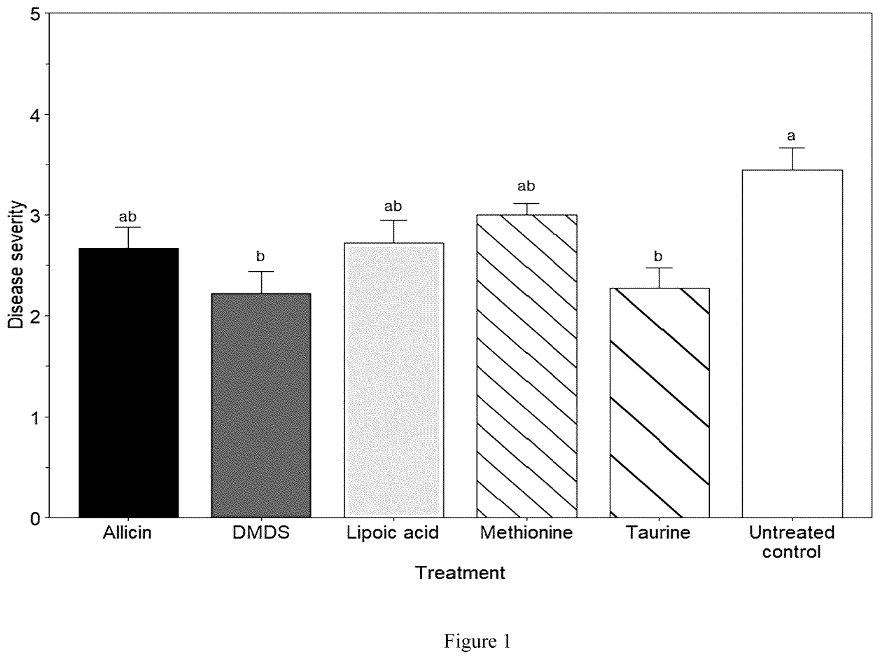

As shown in FIG. 1, the composition containing dimethyl disulfide and taurine exhibit superior effects in suppressing the MFW disease than the other three organic sulfides (allicin, lipoic acid and methionine) used in this example. Compared to the untreated control group (2.33±0.21), the disease severity of melons in the two organic sulfide-treated groups (1.83±0.25 in DMDS group and 2.00±0.18 in taurine group, respectively) are significantly reduced.

The results show that the foliar spray compositions containing dimethyl disulfide and taurine can significantly inhibit the infection of soilborne pathogen Fusarium oxysporum f.sp. melonis (FOM) and reduce the disease severity in melon plants. Moreover, the addition of these organic sulfides will not adversely affect the photosynthesis of melon leaves and will not harm the normal growth of melon plants.

### Example 2. Evaluation of the Effects of DMDS Combined with Different Carbon Source in Controlling Melon Fusarium Wilt (MFW)

A foliar spray composition is prepared by mixing 3% (w/v) a carbon sources, including D(−) fructose, D(+) galactose, glucose, inositol or sucrose, with 1% (w/v) DMDS homogeneously, and then diluted 400-fold with distilled water. The diluted compositions are sprayed on the whole melon plants at 7 and 14 days of age, in 3 mL and 6 mL respectively. The group of plants sprayed by sterile distilled water is used as untreated control. At the 24 hours after the final spraying, the root of test melon plants is washed with water to remove the cultivating medium. Then, the inoculation of the spore suspension of Fusarium oxysporum f.sp. melonis (10⁵ spores/mL) is carried out on the cut area of melon root as described in Example 1.

The inoculated melon plants are transplanted into 31/2 inch soft plastic pots (inner diameter: 9 cm) filled with Sondermischung (perlite high) (Gramoflor, Germany) cultivation medium, and continued to cultivate in a greenhouse (with a condition: 28° C. during the day, 26° C. at night; 14 hours of daylight and 10 hours of darkness). After 3 weeks, the symptoms and severity of wilt disease in melon plants are observed and recorded. Each treatment is performed in three replicates, and each replicate consisted of six plants. The test is repeated twice.

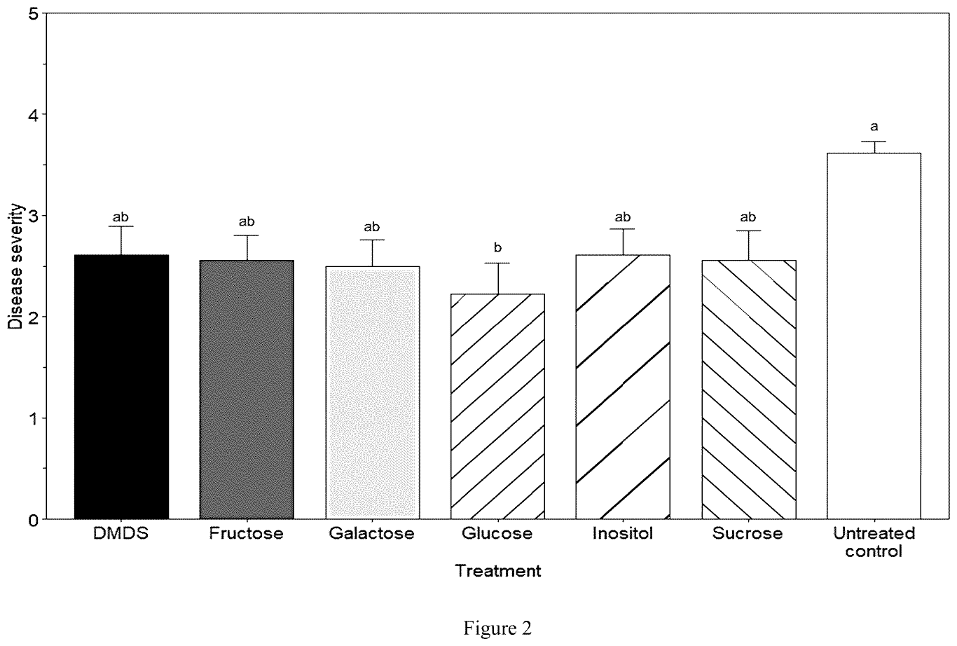

Among the five carbon sources used in this example, the combination of glucose and DMDS exhibits the best suppression effect on melon Fusarium wilt disease (as shown in FIG. 2). Compared with the control group (3.61±0.12), the disease severity of MFW is reduced to 2.22±1.31. Moreover, the combination of DMDS and glucose at a ratio of 1:3 (hereinafter referred to as the SCD composition) is more effective in reducing the disease severity than the solution containing 1% (w/v) DMDS only. The results indicate that the inhibitory effect of DMDS on MFW disease is enhanced by the combination with glucose.

### Example 3. Addition of Mineral Salts Improves the Efficacy of SCD in Melon Fusarium Wilt (MFW) Control

A foliar spray composition is prepared by further mixing the SCD composition (comprising 1% (w/v) DMDS and 3% (w/v) glucose) with or without 1% (w/v) a mineral salt, selected from ammonium sulphate ((NH₄)₂SO₄), dipotassium hydrogen phosphate (K₂HPO₄), potassium Sulfate (K₂SO₄), potassium chloride (KCl), potassium dihydrogen phosphate (KH₂PO₄), potassium nitrate (KNO₃), ammonium nitrate (NH₄NO₃) and urea, and then diluted 400-fold with distilled water. The diluted compositions are sprayed on the whole melon plants at 7 and 14 days of age, in 3 mL and 6 mL respectively. The group of plants sprayed by sterile distilled water is used as untreated control.

At the 24 hours after the final spraying, the root of test melon plants is washed with water to remove the cultivating medium. Then, the inoculation of the spore suspension of Fusarium oxysporum f.sp. melonis (10⁵ spores/mL) is carried out on the cut area of melon root as described in Example 1. The inoculated melon plants are transplanted into 31/2 inch soft plastic pots (inner diameter: 9 cm) filled with Sondermischung (perlite high) (Gramoflor, Germany) cultivation medium, and continued to cultivate in a greenhouse (with a condition: 28° C. during the day, 26° C. at night; 14 hours of daylight and 10 hours of darkness). After 3 weeks, the symptoms and severity of wilt disease in melon plants are observed and recorded. Each treatment is performed in 3 replicates, and each replicate consisted of 6 plants (n=6). The test is repeated twice.

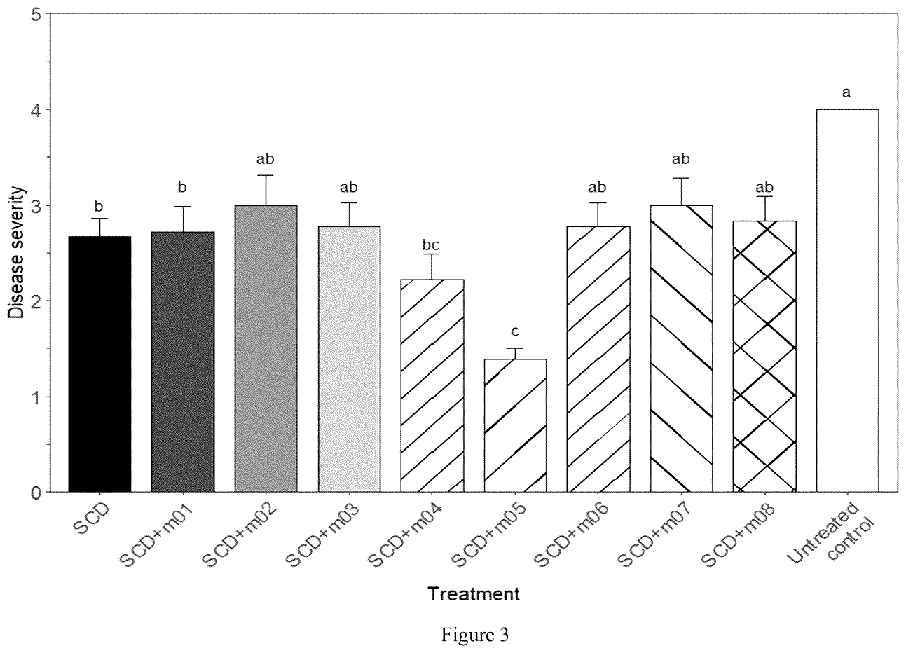

As shown in FIG. 3, The best disease suppression effect is obtained in the melon plants spray applied with the SCD compositions containing potassium chloride (named as SCD+m-04 composition) and potassium dihydrogen phosphate (named as SCD+m-05 composition). The disease severity of MFW in SCD+m-04 and SCD+m-05 treated group are reduced to 2.00±0.18 and 1.83±0.15, when compared to the untreated control group (3.61±0.12). It is indicated that the addition of potassium chloride or potassium dihydrogen phosphate to the SCD solution comprising DMDS and glucose will effectively reduce the damage caused by MFW in melon plants, and the severity of wilt disease is significantly lower than that in control group. Moreover, comparing with the plants treated with the SCD composition (severity of 2.11), the addition of potassium chloride or potassium dihydrogen phosphate may further enhance the effectiveness of the SCD composition in controlling melon Fusarium wilt.

### Example 4. Effects of SCD+m-05 Composition on the Control of Melon Fusarium Wilt (MFW) in Field Microplot Test

Based on the results described in Example 3, the efficacy of SCD+m-05 composition (that is an aqueous solution comprising 1% (w/v) dimethyl disulfide, 3% (w/v) glucose and 1% (w/v) potassium dihydrogen phosphate) in the control of melon Fusarium wilt (MFW) is further evaluated in a field microplot test. The field microplot test is conducted in a greenhouse and the 56 L planting bags (42 cm diameter and 40 cm high) for tested melon plants growing are prepared as following. First, 35 L of uninfected cultivating medium is added to an empty 56 L bag. Then, 5 L of pathogen infected soil (prepared by mixing the cultivating medium with a spore suspension of Fusarium oxysporum f.sp. melonis, 10³ spores/mL) is added and finally covered with 2 L of uninfected cultivating medium.

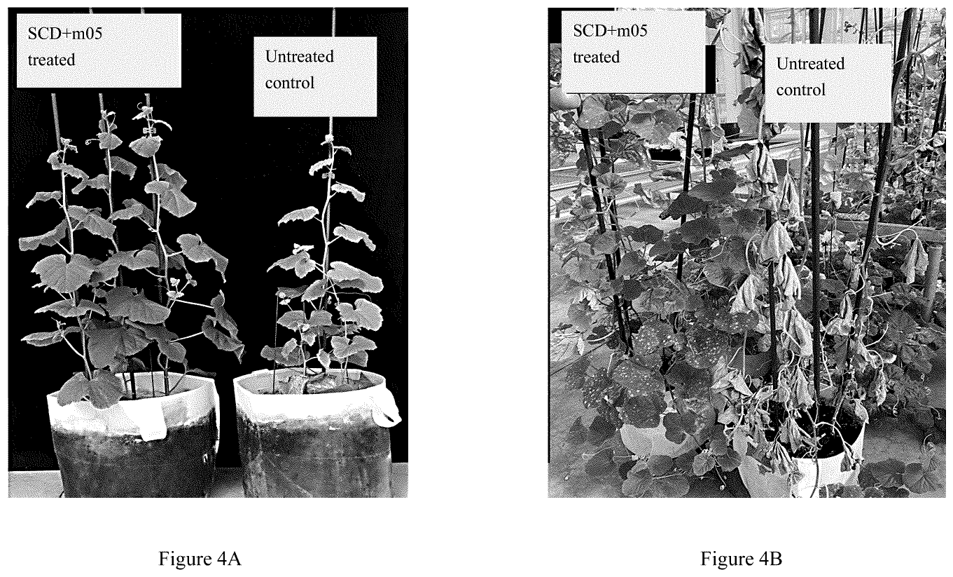

The melon plants are cultivated in an incubator at 28° C. (day)/26° C. (night) with 14 hrs of light/10 hrs of dark for 14 days. The SCD+m-05 composition (at 400 folds dilution in distilled water) is applied to melon plants through foliar spraying every 7 days for two consecutive weeks. The group of plants applied with sterile distilled water is used as untreated control. After the foliar spray application, melon seedlings are transplanted into the prepared 56 L planting bags containing pathogen infected soil, five bags of four plants per treatment (n=4). During the period of field microplot test, melon seedlings are maintained in a greenhouse for eight weeks. All planting bags are hydrated with the same amount of water daily through an automatic watering system, and fertilized twice a week. The growth and disease symptom in melon seedlings are observed and investigated from the first day after transplanting into pathogen infected soil. The disease severity of melon Fusarium wilt in melon plants are recorded on a scale of 0-4 as described in Example 1 at the days of fourth and sixth weeks after transplanting. The results are listed in Table 2 below and shown in FIG. 4.

TABLE 2
The effect of SCD + m-05 composition on controlling
melon Fusarium wilt caused by Fusarium oxysporum
f. sp. melonis through foliar spraying.

| Treatment | Disease severity^{b} | |
|---|---|---|
| SCD + m-05^{a} | 1.65 ± 0.36 | b |
| Untreated control | 2.65 ± 0.24 | a |

Footnote:
^{a}SCD + m-05 composition based on glucose, DMDS and KH₂PO₄, diluted 400 times with distilled water, is foliar applied on the leaves of the melon in two consecutive week.
^{b}Each in five replicates, and each replicate consisted of four plants. Means (n = 4) in the same application method followed by different letters are significantly different (p < 0.05) according to Kruskal-Wallis test with a Dunn's post-hoc test. Result was presented as mean ± standard error (SE).

As shown in Table 2, at the fourth week after transplanting into infected soil that had been inoculated with pathogen FOM, the disease severity in the melon plants treated with SCD+m-05 composition (1.65−0.36) is significantly lower than that in the untreated control (2.65−0.24). The data indicated that the treatment of SCD+m-05 composition through foliar spraying can significantly reduce the disease severity of melon Fusarium wilt caused by soil-borne pathogen Fusarium oxysporum f.sp. melonis.

Furthermore, a lower disease severity of MFW is observed in the SCD+m-05 composition treated group at the fourth week after transplanted into pathogen infected soil, with only one melon plant showing wilting symptoms and dying (as shown in FIG. 4A, Left side). On the other hand, the melon plants not treated with SCD+m-05 composition (as untreated control) are more susceptible to MFW, with observation that symptoms of wilt are present in all control melon plants and three melon plants are dead (FIG. 4A, Right side).

FIG. 4B shows the growing condition of melon plants are observe at the sixth week after transplanting in the field microplot test. It is found that the melon plants treated with the SCD+m-05 composition only present wilting symptoms (FIG. 4B, Left side), whereas all of the melon plants not treated with the SCD+m-05 composition (as untreated control) are withered and dead (FIG. 4B, Right side). The results indicate that effect of the SCD+m-05 application through foliar spraying on controlling melon Fusarium wilt (MFW) is quite obvious. Therefore, by utilizing the SCD+m-05 composition of the present invention in field application, melon seedlings can be effectively protected from the damage caused by the pathogen Fusarium oxysporum f.sp. melonis (FOM) existing in the infected soil.

In summary, the use of foliar spraying a composition of organic sulfide combined with glucose and/or potassium mineral salt to melon plants can effectively prevent the infection of soil-borne pathogen FOM and reduce the incidence and disease severity of melon Fusarium wilt, and thus will achieve the projected objectives of preventing and controlling wilt disease in melons.

Although a limited number of embodiments are described to illustrate the practice of the present invention, those skilled in the art may still make modifications or changes according to the description. Therefore, the scope of the present invention should only be limited by the claims of the patent, and not limited to the above examples.

What is claimed is:

1. A composition for controlling melon Fusarium wilt (MFW), comprising an organic sulfide and a carbon source combined at a ratio of 1:2˜1:4 (w/w), and an agriculturally acceptable diluent, wherein the organic sulfide is selected from a group composed of allicin, dimethyl disulfide (DMDS), lipoic acid, methionine and taurine, and the carbon source is glucose.

2. The composition of claim 1, wherein the composition comprises 1% (w/v) of the organic sulfide and 3% (w/v) of glucose, and an agriculturally acceptable diluent.

3. The composition of claim 2, wherein the organic sulfide is dimethyl disulfide (DMDS) or taurine, and the agriculturally acceptable diluent is water.

4. The composition of claim 1, further comprising 1% (w/v) of a potassium containing mineral salt.

5. The composition of claim 4, wherein the potassium containing mineral salt is selected from a group composed of potassium chloride and potassium dihydrogen phosphate.

6. The composition of claim 1, wherein the composition is used to inhibit infection of Fusarium oxysporum f. sp. melonis (FOM) in melons.

7. The composition of claim 1, wherein the composition is used to reduce disease severity of MFW.

8. A method for controlling melon Fusarium wilt (MFW), comprising applying the composition of claim 1 to a melon plant by foliar spraying at a dilution rate of 100˜1000.

9. The method of claim 8, wherein the composition is applied to the melon plant by foliar spraying at a dilution rate of 200˜400.
